(19) United States
(12) Patent Application Publication
(10) Pub. No.: US 2013/0161455 A1
(43) Pub. Date: Jun. 27, 2013

(54) STAND FOR AN ELECTRONIC DEVICE AND METHODS OF PROVIDING AND USING SAME

(71) Applicant: BELKIN INTERNATIONAL, INC., Playa Vista, CA (US)

(72) Inventor: Chad DeJong, Los Angeles, CA (US)

(73) Assignee: BELKIN INTERNATIONAL, INC., Playa Vista, CA (US)

(21) Appl. No.: 13/774,627

(22) Filed: Feb. 22, 2013

Related U.S. Application Data
(63) Continuation of application No. PCT/US2011/048800, filed on Aug. 23, 2011.
(60) Provisional application No. 61/376,251, filed on Aug. 23, 2010.

(51) Int. Cl. F16M 11/04

(52) U.S. Cl. CPC F16M 11/04
USPC 248/176.3

(57) ABSTRACT

Some embodiments include a stand for an electronic device. Other embodiments of related stands and methods of providing and using the same are disclosed.

### CROSS-REFERENCE TO RELATED APPLICATIONS

This application is a continuation of International Patent Application Serial No. PCT/US2011/048800, filed Aug. 23, 2011. International Patent Application Serial No. PCT/US2011/048800 claims the benefit of U.S. Provisional Application No. 61/376,251, filed Aug. 23, 2010. International Patent Application Serial No. PCT/US2011/048800 and U.S. Provisional Application No. 61/376,251 are incorporated by reference herein in their entirety.

### FIELD OF THE INVENTION

This invention relates generally to stands for electrical devices, and relates more particularly to stands configured to permit adjustment of viewing angles of the electronic devices and methods of providing and using the same.

### DESCRIPTION OF THE BACKGROUND

Many electronic devices lack a form factor permitting the electronic devices to maintain and/or to be self supporting in a position that is desirable for operation and/or use of the electronic device. Uneven surfaces further complicate the inability of these electronic devices to maintain and/or to be self supporting in the position that is desirable for operation and/or use of the electronic device. Accordingly, a need or potential for benefit exists for a stand that can support an electronic device at various viewing angles above and/or upon uneven surfaces while one or more users operate and/or use the electronic device.

### BRIEF DESCRIPTION OF THE DRAWINGS

To facilitate further description of the embodiments, the following drawings are provided in which:

FIG. 1 illustrates a left side rear isometric view of a stand for an electronic device, according to an embodiment;

FIG. 2 illustrates the electronic device coupled to the stand, according to the embodiment of FIG. 1;

FIG. 3 illustrates a left side rear isometric view of a stand for an electronic device, according to an embodiment;

FIG. 4 illustrates the electronic device coupled to the stand, according to the embodiment of FIG. 3;

FIG. 5 shows an exemplary male connector of a first receiver mechanism of a flexible arm with respect to an exemplary female connector of a connection port of a case, according to the embodiment of FIGS. 3 and 4;

FIG. 6 illustrates a flow chart for an embodiment of a method for providing a stand for an electronic device;

FIG. 7 illustrates a flow chart for an embodiment of a method of using a stand for an electronic device;

FIG. 8 illustrates an exemplary procedure of coupling the electronic device to the stand via a first receiver mechanism, according to the method of FIG. 7; and

FIG. 9 illustrates an exemplary procedure of positioning the stand on a surface of an object such that the stand at least partially supports the electronic device to hold the electronic device substantially steady, according to the method of FIG. 7.

For simplicity and clarity of illustration, the drawing figures illustrate the general manner of construction, and descriptions and details of well-known features and techniques may be omitted to avoid unnecessarily obscuring the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein.

The terms “couple,” “coupled,” “couples,” “coupling,” and the like should be broadly understood and refer to connecting two or more elements or signals, electrically, mechanically and/or otherwise. Two or more electrical elements may be electrically coupled together, but not be mechanically or otherwise coupled together; two or more mechanical elements may be mechanically coupled together, but not be electrically or otherwise coupled together; two or more electrical elements may be mechanically coupled together, but not be electrically or otherwise coupled together. Coupling may be for any length of time, e.g., permanent or semi-permanent or only for an instant.

“Electrical coupling” and the like should be broadly understood and include coupling involving any electrical signal, whether a power signal, a data signal, and/or other types or combinations of electrical signals. “Mechanical coupling” and the like should be broadly understood and include mechanical coupling of all types.

The absence of the word “removably,” “removable,” and the like near the word “coupled,” and the like does not mean that the coupling, etc. in question is or is not removable.

The term “mobile electronic device” as used herein refers to at least one of a digital music player, a digital video player, a digital music and video player, a cellular phone (e.g., smartphone), a personal digital assistant, a handheld digital computer (e.g., a calculator, a tablet personal computer, a netbook computer, or a portable gaming console), or another device with the capability to display images and/or videos. For example, a mobile electrical device can comprise the iPod® or iPhone® or iTouch® or iPad® product by Apple Inc. of Cupertino, Calif. Likewise, a mobile electrical device can comprise a Blackberry® product by Research in Motion (RIM) of Waterloo, Ontario, Canada, or a different product by a different manufacturer.

The term “gooseneck” as used herein refers to a structure comprising compliant (or obedient) flexible tubing, and can be metallic or metal covered with, for example, plastic or elastic material on its outside. A gooseneck can be considered to be a coiled layered construction in which adjacent coils overlap, but can be moved with respect to each other (in a sense, slide on each other). A gooseneck tends to hold the position into which it is bent (i.e., it is semi permanently adjustable or repositionable), unless it is bent beyond its limit. The two “layers” of the gooseneck can be considered to have different thicknesses. Thus, a gooseneck can have two outer diameters, the outer diameter of the thicker layer, and the outer diameter of the thinner layer, which alternate in the gooseneck.

### DETAILED DESCRIPTION OF EXAMPLES OF EMBODIMENTS

Some embodiments include a stand for a mobile electronic device. The stand comprises a support body comprising a lateral surface, a first support body end, and a second support body end opposite the first support body end. The stand also comprises a flexible arm comprising a device arm end, a support body arm end opposite the device arm end, and a first receiver mechanism at the device arm end. The flexible arm can be coupled to the lateral surface of the support body at the support body arm end. The first receiver mechanism can be configured to permit the electronic device to be coupled to the flexible arm.

Various embodiments include a method for providing a stand for a mobile electronic device. The method can comprise: providing a support body having a lateral surface, a first support body end, and a second support body end opposite the first support body end; providing a flexible arm comprising a device arm end, a support body arm end opposite the device arm end, and a first receiver mechanism at the device arm end; and coupling the flexible arm to the lateral surface of the support body at the support body arm end. The first receiver mechanism is configured to permit the electronic device to be coupled to the flexible arm.

Further embodiments include a method of using a stand for an electronic device. The method can comprise coupling the electronic device to the stand via a first receiver mechanism. The stand can comprise (a) a support body having a lateral surface, a first support body end, and a second support body end opposite the first support body end and (b) a flexible arm comprising a device arm end, a support body arm end opposite the device arm end, and a first receiver mechanism at the device arm end. The flexible arm can be coupled to the lateral surface of the support body at the support body arm end. The first receiver mechanism can be configured to permit the electronic device to be coupled to the flexible arm. After coupling the electronic device to the stand, the method can also comprise positioning the stand on a surface of an object such that the stand at least partially supports the electronic device to hold the electronic device substantially steady.

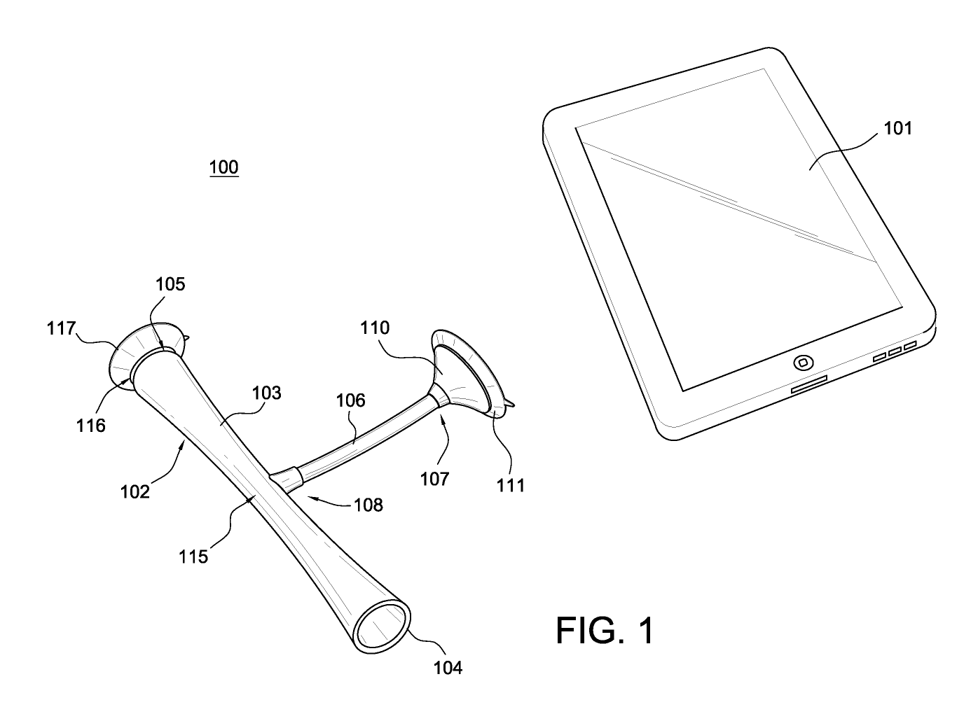

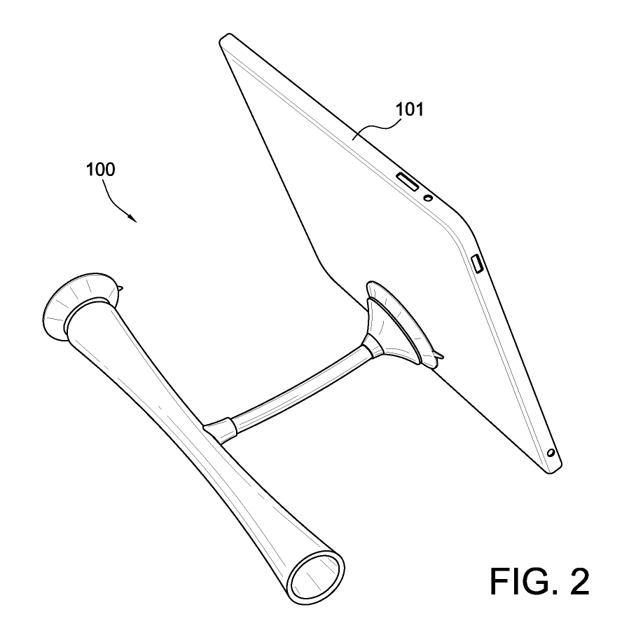

Turning to the drawings, FIG. 1 illustrates a left side rear isometric view of stand 100 for electronic device 101, according to an embodiment. Stand 100 is merely exemplary and is not limited to the embodiments presented herein. Stand 100 can be employed in many different embodiments or examples not specifically depicted or described herein. FIG. 1 illustrates electronic device 101 separate from stand 100, but FIG. 2 illustrates electronic device 101 when electronic device 101 is coupled to stand 100, as described herein.

Referring now to FIG. 1, stand 100 comprises support body 102. Support body 102 can comprise lateral surface 103, first support body end 104, and second support body end 105. Second support body end 105 can be opposite to first support body end 104.

Meanwhile, stand 100 also comprises flexible arm 106. Flexible arm 106 can comprise device arm end 107, support body arm end 108, and/or first receiver mechanism 110. Support body arm end 108 can be opposite to device arm end 107. In many embodiments, device arm end 107 can comprise and/or can be coupled to first receiver mechanism 110.

In many embodiments, flexible arm 106 and/or first receiver mechanism 110 can comprise first suction cup 111. In some embodiments, second support body end 105 can comprise second receiver mechanism 116. In these embodiments, second receiver mechanism 116 can comprise second suction cup 117. Accordingly, first and second support body ends 104 and 105 are not symmetric or identical with each other, in the illustrated embodiment of FIG. 1. Similarly, first and second support body ends 104 and 105 are also not symmetric or identical with device arm end 107 or support body arm end 108 in this embodiment. Finally, device arm end 107 and support body arm end 108 are also not symmetric or identical with each other in this embodiment. In other embodiments, two or more of first and second support body ends 104 and 105 and device arm end 107 can be symmetric or identical with each other.

In many embodiments, electronic device 101 can comprise a mobile electronic device, as described above. In some embodiments, stand 100 can comprise electronic device 101.

Flexible arm 106 can be coupled to support body 102. In various embodiments, flexible arm 106 can be coupled to support body 102 at lateral surface 103 of support body 102. Flexible arm 106 can be coupled to support body 102 and/or lateral surface 103 at support body arm end 108. In these embodiments, support body arm end 108 can be coupled to support body 102 and/or lateral surface 103 at approximately midpoint 115. Midpoint 115 can be located approximately equidistant between first support body end 104 and second support body end 105 of support body 102. Likewise, midpoint 115 can be located at lateral surface 103 of support body 102.

In some embodiments, flexible arm 106 can be removably coupled to support body 102 at support body arm end 108. For example, in some embodiments, flexible arm 106 can be removably coupled to support body 102 via a threaded fastener of support body 102. In these embodiments, flexible arm 106 can comprise threads located at support body arm end 108 configured to be coupled to the threaded fastener of support body 102. In another example, flexible arm 106 can comprise a loop fastener configured to close around support body 102 and/or a clamp fastener configured to clamp to support body 102 in order to couple flexible arm 106 to support body 102. In still other embodiments, flexible arm 106 can be removably coupled to support body 102 via any other suitable fastener.

In many embodiments, flexible arm 106 can be manipulated by a force applied by a user of stand 100 and/or electronic device 101 to flexible arm 106 so as to reorient flexible arm 106, first receiver mechanism 110, and/or electronic device 101 with respect to support body 102. Flexible arm 106 can be implemented as a gooseneck, as described above, or any other suitably flexible device. In many embodiments, where flexible arm 106 is implemented as a gooseneck, the gooseneck can be a gooseneck device of Sheenway (Hong Kong) Limited, located at Room 1313, 13/F., Austin Tower, Kowloon, Hong Kong. In some embodiments, flexible arm 106 can be rigid rather than flexible.

First receiver mechanism 110 and/or device arm end 107 can be configured to permit electronic device 101 to be coupled to flexible arm 106 and/or stand 100. Accordingly, first suction cup 111 can be configured to be coupled to electronic device 101 so as to couple electronic device 101 to flexible arm 106 and/or stand 100. Meanwhile, second receiver mechanism 116 and/or second suction cup 117 can be configured to be coupled to electronic device 101 or any other suitable object(s). For example, the other suitable object(s) can comprise a desk and/or table surface, a wall surface, a computer surface and/or computer display (e.g., monitor) surface, etc. Either or both of first suction cup 111 and/or second suction cup 117 can be implemented as a suction cup provided by Sheenway (Hong Kong) Limited, located at Room 1313, 13/F., Austin Tower, Kowloon, Hong Kong. In other embodiments, first receiver mechanism 110 can comprise any other suitable suction mechanism configured to couple electronic device 101 to flexible arm 106 and/or stand 100.

In some embodiments, a portion or all of lateral surface 103 of support body 102 can be curved (e.g., parabolic) and concave and/or convex. In other embodiments, a portion or all embodiments, a portion or all of lateral surface 103 of support body 102 can comprise a constant cross section. In various embodiments, the cross section of lateral surface 103 can be cylindrical, triangular, square, pentagonal, hexagonal, octagonal, or any other suitable geometric polygon.

In many embodiments, support body 102 can comprise one or more materials. The material(s) of support body 102 can comprise acrylonitrile butadiene styrene (ABS) and/or polycarbonate (PC). Support body 102 can be solid or hollow. Meanwhile, flexible arm 106 can comprise one or more materials that can be similar to, identical to, or different from the material(s) of support body 102. For example, the material(s) of flexible arm 106 can comprise wound steel, aluminum, etc. Furthermore, first receiver mechanism 100 and/or second receiver mechanism 116 can comprise one or more materials similar or identical to the material(s) of support body 102 and/or flexible arm 106. Likewise, first suction cup 111 and/or second suction cup 117, when applicable respectively, can comprise one or more materials. For example, the material(s) of first suction cup 111 and/or second suction cup 117 can comprise at least one of silicone, polyvinyl chloride, or a thermoplastic polyurethane.

In operation, stand 100 can be configured to permit electronic device 101 to be adjusted so that a display (e.g., a touch screen display) of electronic device 101 is oriented at a desired angle with respect to (a) one or more reference objects (explained below) upon which support body 102 and/or flexible arm 106 are located and/or (b) one or more users of stand 100 and/or electronic device 101. Accordingly, stand 100 can operate as an adjustable support for electronic device 101 to hold electronic device 101 steady in a desired position, such as, when a user is operating and/or using electronic device 101.

The reference object(s) can comprise a desk and/or table surface, a wall surface, a computer surface and/or computer display (e.g., monitor) surface, a user's lap or other body parts, etc. In some examples, the reference object(s) can comprise the other object(s) referenced above with respect to second receiver mechanism 116 and/or second suction cup 117. In other embodiments, the reference object(s) can comprise one or more objects other than the other object(s) referenced above with respect to second receiver mechanism 116 and/or second suction cup 117.

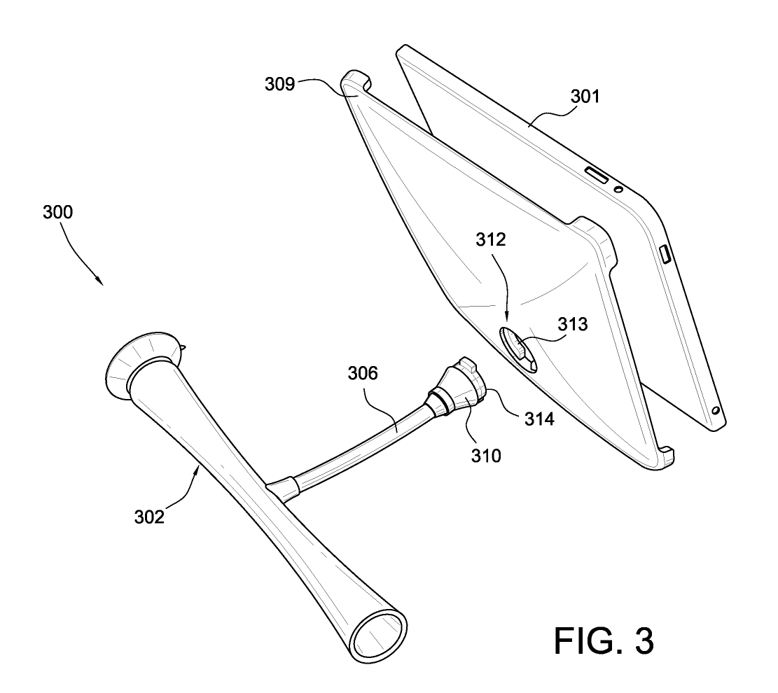

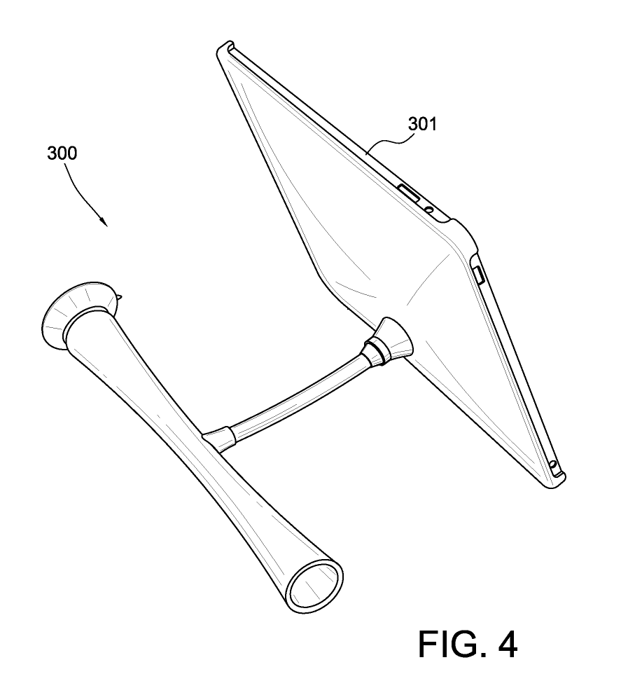

Turning to the next drawing, FIG. 3 illustrates a left side rear isometric view of stand 300 for electronic device 301, according to an embodiment. Stand 300 is merely exemplary and is not limited to the embodiments presented herein. Stand 300 can be employed in many different embodiments or examples not specifically depicted or described herein. Stand 300 can be similar or identical to stand 100 (FIG. 1), and electronic device 301 can be similar or identical to electronic device 101 (FIG. 1). FIG. 3 illustrates electronic device 301 separate from stand 300, but FIG. 4 illustrates electronic device 301 when electronic device 301 is coupled to stand 300, as described herein.

Referring to FIG. 3, stand 300 can comprise case 309. Case 309 can comprise connection port 312, and connection port 312 can comprise female connector 313. Meanwhile, stand 300 can further comprise first receiver mechanism 310 and/or flexible arm 306. First receiver mechanism 310 can comprise male connector 314. In many embodiments, first receiver mechanism 310 can be similar or identical to first receiver mechanism 110 (FIG. 1), and/or flexible arm 306 can be similar or identical to flexible arm 106 (FIG. 1). Furthermore, stand 300 can also comprise support body 302, which can be similar or identical to support body 101 (FIG. 1).

Case 309 can be configured to receive and/or at least partially enclose electronic device 301 such that electronic device 301 is at least partially located in case 309. According, case 309 can be configured to provide protection for electronic device 301. Case 309 can be configured to permit access to and/or to leave exposed (a) one or more electrical receptacles, (b) one or more audio-visual components (e.g., an electronic display, a speaker, a microphone, a camera, etc.), and/or (c) one or more input mechanisms (e.g., buttons, switches, etc.) configured to operate at least some of the functionality of electronic device 301, when electronic device 301 is located in case 309.

Meanwhile, case 309 can be configured to be coupled (e.g., removably, permanently) to flexible arm 306 and/or first receiver mechanism 310 (e.g., via coupling male connector 314 to female connector 313, or vice versa). Accordingly, connection port 312 can be configured to receive first receiver mechanism 310 in order to couple case 309 to flexible arm 306 such that when case 309 receives electronic device 301, electronic device 301 is coupled to flexible arm 306. Furthermore, female connector 313 can correspond to male connector 314 of first receiver mechanism 310.

When case 309 is configured to be removed from first receiver mechanism 310, case 309 can operate as a stand alone case for electronic device 301, thereby providing an improved user experience (e.g., enhanced protection, etc.) when using electronic device 301 apart from the remaining elements of stand 300 in addition to when case 309 is coupled with the remaining elements of stand 300 to provide additional advantages (e.g., support for electronic device 301, etc.), further improving the user experience.

Case 309 can comprise one or more materials. The material(s) of case 309 can be similar or identical to the material(s) described above for solid body 102 (FIG. 1) and/or flexible arm 106 (FIG. 1).

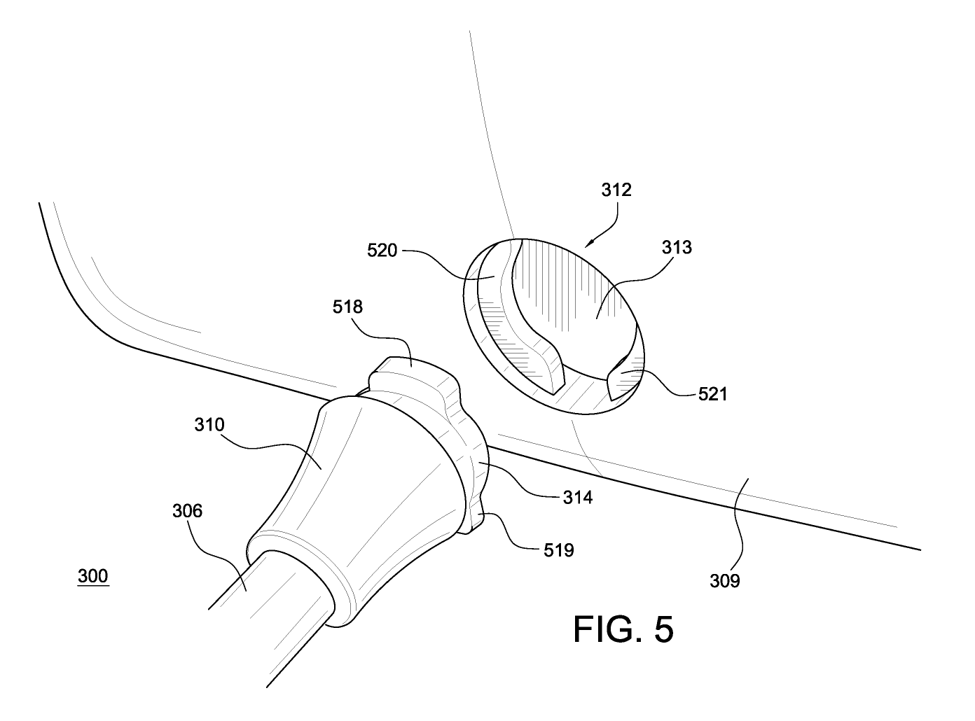

For illustrative purposes, FIG. 5 shows an exemplary male connector 314 of first receiver mechanism 310 and/or flexible arm 306 with respect to an exemplary female connector 313 of connection port 312 of case 309, according to the embodiment of FIGS. 3 and 4. Accordingly, male connector 314 can comprise flange 518 and/or flange 519 configured to rotationally mate with tab 520 and/or tab 521 of female connector 313. Nonetheless, male connector 314 and female connector 313 can be implemented according to any other suitable coupling scheme, such as, for example, a threaded fastening scheme similar or identical to the fastening scheme described above with respect to support body 102 and flexible arm 106.

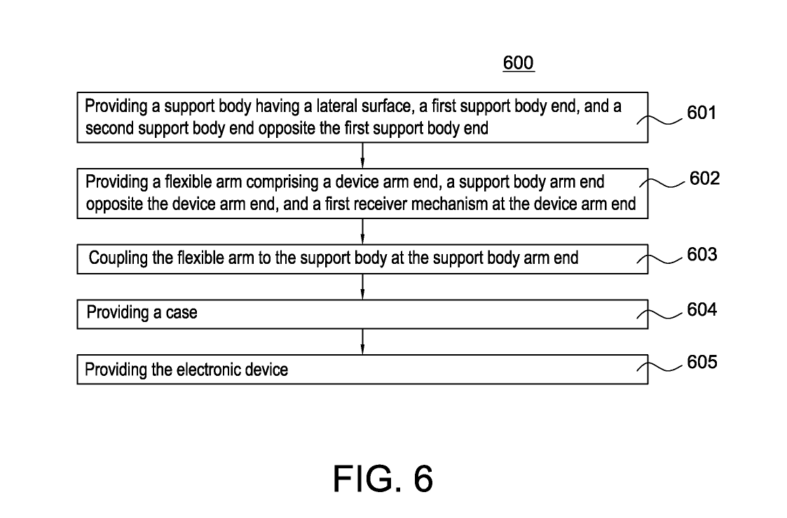

FIG. 6 illustrates a flow chart for an embodiment of method 600 for providing a stand for an electronic device. Method 600 is merely exemplary and is not limited to the embodiments presented herein. Method 600 can be employed in many different embodiments or examples not specifically depicted or described herein. In some embodiments, the procedures, the processes, and/or the activities of method 600 can be performed in the order presented. In other embodiments, the procedures, the processes, and/or the activities of the method 600 can be performed in any other suitable order. In still other embodiments, one or more of the procedures, the processes, and/or the activities in method 600 can be combined or skipped. The stand can be similar or identical to stand 100 (FIG. 1) and/or stand 300 (FIG. 3). The electronic device can be similar or identical to electronic device 101 (FIG. 1) and/or electronic device 301 (FIG. 3).

Referring to FIG. 6, method 600 can comprise procedure 601 of providing a support body having a lateral surface, a first support body end, and a second support body end opposite the first support body end. The support body can be similar or identical to support body 102 (FIG. 1). The lateral surface can be similar or identical to lateral surface 103 (FIG. 1), the first support body end can be similar or identical to first support body end 104 (FIG. 1), and/or the second support body end can be similar or identical to second support body end 105 (FIG. 1).

Method 600 can comprise procedure 602 of providing a flexible arm comprising a device arm end, a support body arm end opposite the device arm end, and a first receiver mechanism at the device arm end. The flexible arm can be similar or identical to flexible arm 106 (FIG. 1). The device arm end can be similar or identical to device arm end 107 (FIG. 1), and/or the support body arm end can be similar or identical to support body arm end 108 (FIG. 1). The first receiver mechanism can be similar or identical to first receiver mechanism 110 (FIG. 1) and/or first receiver mechanism 310 (FIG. 3). Procedures 601 and 602 can be performed sequentially (in any order) or simultaneously with respect to each other.

Method 600 can comprise procedure 603 of coupling the flexible arm to the support body at the support body arm end. Performing procedure 603 can comprise coupling the flexible arm to the support body in a manner as described above with respect to stand 100 (FIG. 1). In some embodiments, procedure 603 can be performed after procedures 601 and 602. In many embodiments, procedure 603 can be omitted.

In some embodiments, method 600 can comprise optional procedure 604 of providing a case. The case can be similar or identical to case 309 (FIG. 3). In some embodiments, procedure 604 can be omitted.

Method 600 can comprise optional procedure 605 of providing the electronic device.

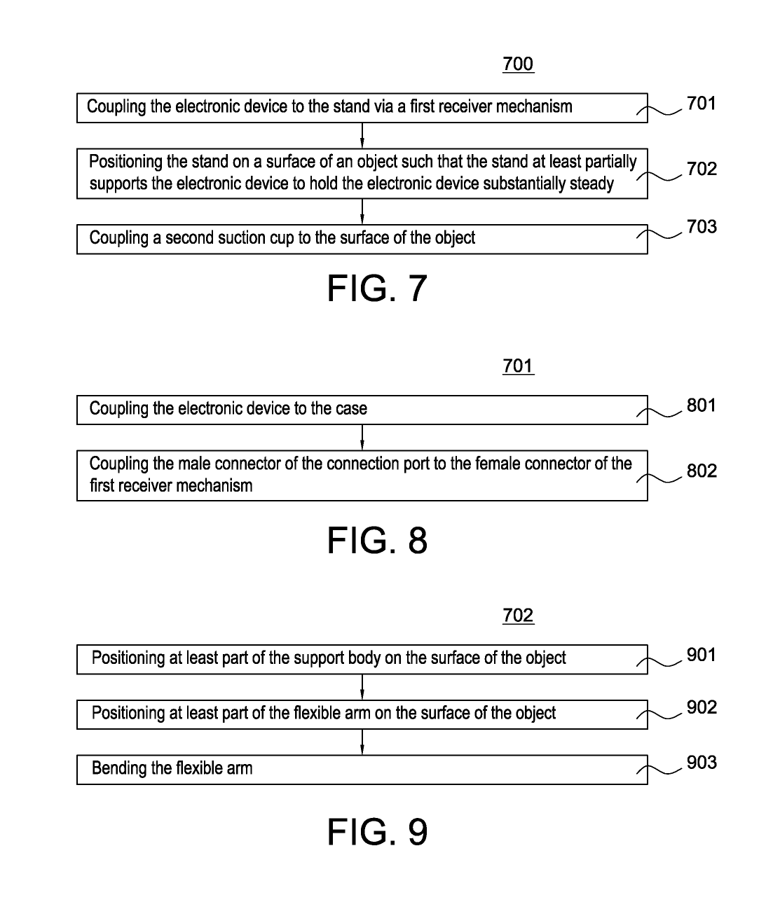

FIG. 7 illustrates a flow chart for an embodiment of method 700 of using a stand for an electronic device. Method 700 is merely exemplary and is not limited to the embodiments presented herein. Method 700 can be employed in many different embodiments or examples not specifically depicted or described herein. In some embodiments, the procedures, the processes, and/or the activities of method 700 can be performed in the order presented. In other embodiments, the procedures, the processes, and/or the activities of the method 700 can be performed in any other suitable order. In still other embodiments, one or more of the procedures, the processes, and/or the activities in method 700 can be combined or skipped. The stand can be similar or identical to stand 100 (FIG. 1) and/or stand 300 (FIG. 3). The electronic device can be similar or identical to electronic device 101 (FIG. 1) and/or electronic device 301 (FIG. 3).

Referring to FIG. 7, method 700 can comprise procedure 701 of coupling the electronic device to the stand via a first receiver mechanism. The first receiver mechanism can be similar or identical to first receiver mechanism 110 (FIG. 1) and/or first receiver mechanism 310 (FIG. 3).

In embodiments where the first receiver mechanism comprises a first suction cup, procedure 701 can comprise coupling the electronic device to the stand further comprises coupling the first suction cup to the electronic device. The first suction cup can be similar or identical to first suction cup 111 (FIG. 1). Meanwhile, in other embodiments, where the stand further comprises a case, the case is configured to receive the electronic device, and the case is configured to be coupled to the first receiver mechanism by a connection port of the case, procedure 701 can comprise: (a) process 801 of coupling the electronic device to the case; and (b) process 802 of coupling the first receiver mechanism to the connection port, as illustrated in FIG. 8. In these embodiments, process 802 can comprise coupling the male connector of the connection port to the female connector of the first receiver mechanism. The case can be similar or identical to case 309 (FIG. 3). The connection port can be similar or identical to connection port 312 (FIG. 3). The male connector can be similar or identical to male connector 314 (FIG. 3), and/or the female connector can be similar or identical to female connector 313 (FIG. 3). Processes 801 and 802 can be performed sequentially in any order.

Returning to FIG. 7, method 700 can continue with procedure 702 of positioning the stand on a surface of an object such that the stand at least partially supports the electronic device to hold the electronic device substantially steady. The term “substantially steady” can mean being devoid of motion to an extent that would permit electronic device 101 to be used. The object can be similar or identical to the reference object(s) described above with respect to stand 100 (FIG. 1). Procedure 702 can be performed after procedure 701.

In various embodiments, as illustrated at FIG. 9, procedure 702 can comprise: (a) process 901 of positioning at least part of the support body on the surface of the object; (b) process 902 of positioning at least part of the flexible arm on the surface of the object; and/or (c) process 903 of bending the flexible arm.

Returning once more to FIG. 7, method 700 can comprise optional procedure 703 of coupling a second suction cup to the surface of the object. The second suction cup can be similar or identical to second suction cup 117 (FIG. 1).

Although the invention has been described with reference to specific embodiments, it will be understood by those skilled in the art that various changes may be made without departing from the spirit or scope of the invention. Accordingly, the disclosure of embodiments of the invention is intended to be illustrative of the scope of the invention and is not intended to be limiting. It is intended that the scope of the invention shall be limited only to the extent required by the appended claims. For example, to one of ordinary skill in the art, it will be readily apparent that procedures 601-605 of FIG. 6, procedure 701-703 of FIG. 7, processes 801 and 802 of FIG. 8, and processes 901-903 of FIG. 9 may be comprised of many different procedures, processes, and activities and be performed by many different modules, in many different orders, that any element of FIGS. 1-9 may be modified, and that the foregoing discussion of certain of these embodiments does not necessarily represent a complete description of all possible embodiments.

All elements claimed in any particular claim are essential to the embodiment claimed in that particular claim. Consequently, replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are expressly stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1) A stand for a mobile electronic device, the stand comprising:
an arm comprising a device arm end, a support body arm end opposite the device arm end, and a first receiver mechanism at the device arm end;
wherein:
the first receiver mechanism is configured to permit the mobile electronic device to be coupled to the arm.

2) The stand of claim 1 wherein:
the first receiver mechanism comprises a first suction cup configured to couple the first receiver mechanism to the mobile electronic device.

3) The stand of claim 1 further comprising:
a support body comprising a lateral surface, a first support body end, and a second support body end opposite the first support body end;
wherein:
the arm is coupled to the lateral surface of the support body at the support body arm end.

4) The stand of claim 3 wherein:
the first receiver mechanism comprises a first suction cup configured to couple the first receiver mechanism to the mobile electronic device.

5) The stand of claim 3 wherein:
the arm comprises a flexible arm.

6) The stand of claim 3 further comprising:
a case;
wherein:
the case is configured to receive the mobile electronic device; and
the case is configured to be coupled to the first receiver mechanism.

7) The stand of claim 6 wherein:
the case comprises a connection port; and
the connection port is configured to receive the first receiver mechanism in order to couple the case to the arm such that when the case receives the mobile electronic device, the mobile electronic device is coupled to the arm.

8) The stand of claim 7 wherein at least one of:
(i) the first receiver mechanism comprises a male connector, and the connection port comprises a female connector corresponding to the male connector of the first receiver mechanism; or (ii) the arm comprises a flexible arm.

9) The stand of claim 3 wherein at least one of:
the arm is removably coupled to the support body at the support body arm end; or
the support body arm end of the arm is coupled to the support body at approximately a midpoint between the first support body end and the second support body end of the support body.

10) The stand of claim 3 wherein at least one of:
at least a portion of the lateral surface of the support body is parabolic and concave; or
the first support body end comprises a second receiver mechanism, and the second receiver mechanism comprises a second suction cup configured to be coupled to at least one of the mobile electronic device or another object.

11) A method for providing a stand for a mobile electronic device, the method comprising:
providing a support body having a lateral surface, a first support body end, and a second support body end opposite the first support body end;
providing an arm comprising a device arm end, a support body arm end opposite the device arm end, and a first receiver mechanism at the device arm end; and
coupling the arm to the lateral surface of the support body at the support body arm end;
wherein:
the first receiver mechanism is configured to permit the mobile electronic device to be coupled to the arm.

12) The method of claim 11 wherein at least one of:
the first receiver mechanism comprises a first suction cup configured to couple the first receiver mechanism to the mobile electronic device; or
the arm comprises a flexible arm.

13) The method of claim 11 further comprising:
providing a case;
wherein:
the case is configured to receive the mobile electronic device; and
the case is configured to be coupled to the first receiver mechanism.

14) The method of claim 13 wherein:
the case comprises a connection port; and
the connection port is configured to receive the first receiver mechanism in order to couple the case to the arm such that when the case receives the mobile electronic device, the mobile electronic device is coupled to the arm.

15) The method of claim 14 wherein:
the first receiver mechanism comprises a male connector; and
the connection port comprises a female connector corresponding to the male connector of the first receiver mechanism.

16) The method of claim 11 wherein at least one of:
the arm is removably coupled to the support body at the support body arm end;
the support body arm end of the arm is coupled to the support body at approximately a midpoint between the first support body end and the second support body end of the support body;
at least a portion of the lateral surface of the support body is parabolic and concave; or
the first support body end comprises a second receiver mechanism, and the second receiver mechanism comprises a second suction cup configured to be coupled to at least one of the mobile electronic device or another object.

17) A method of using a stand for a mobile electronic device, the method comprising:
coupling the mobile electronic device to the stand via a first receiver mechanism, wherein:
the stand comprises (a) a support body having a lateral surface, a first support body end, and a second support body end opposite the first support body end and (b) an arm comprising a device arm end, a support body arm end opposite the device arm end, and a first receiver mechanism at the device arm end;
the arm is coupled to the lateral surface of the support body at the support body arm end; and
the first receiver mechanism is configured to permit the mobile electronic device to be coupled to the arm;
and
after coupling the mobile electronic device to the stand, positioning the stand on a surface of an object such that the stand at least partially supports the mobile electronic device to hold the mobile electronic device substantially steady.

18) The method of claim 17 wherein at least one of:
the first receiver mechanism comprises a first suction cup, and coupling the mobile electronic device to the stand further comprises coupling the first suction cup to the mobile electronic device; or
the arm comprises a flexible arm.

19) The method of claim 17 wherein:
the stand further comprises a case;
the case is configured to receive the mobile electronic device;
the case is configured to be coupled to the first receiver mechanism by a connection port of the case; and
coupling the mobile electronic device to the stand further comprises:
coupling the mobile electronic device to the case; and
coupling the first receiver mechanism to the connection port.

20) The method of claim 17 wherein:
(i) positioning the stand on the surface of the object comprises at least one of (a) positioning at least part of the support body on the surface of the object, (b) positioning at least part of the arm on the surface of the object, or (c) bending the arm;
or
(ii) the stand further comprises a second receiver mechanism comprising a second suction cup, and the method further comprises coupling the second suction cup to the surface of the object.
